(19) United States
(12) Patent Application Publication
(10) Pub. No.: US 2026/0318880 A1
(43) Pub. Date: Oct. 15, 2026

(54) High-Temperature Miniature Ultrasonic Probes

(71) Applicant: Massachusetts Institute of Technology, Cambridge, MA (US)

(72) Inventors: Hoagy O'Ghaffari, Cambridge, MA (US); Matej Pec, Boston, MA (US)

(21) Appl. No.: 19/114,618

(22) PCT Filed: Oct. 16, 2023
(86) PCT No.: PCT/US2023/035214

§ 371 Date: Mar. 24, 2025

Related U.S. Application Data
(60) Provisional application No. 63/422,952, filed on Nov. 5, 2022.

(51) Int. Cl. G01N 29/22; G01N 29/24

(52) U.S. Cl. CPC G01N 29/228; G01N 29/2437

(57) ABSTRACT

The present disclosure is directed to miniature high-temperature ultrasound probes. A device comprising a high temperature piezo-element is disclosed, which is encapsulated within highly anti-oxidizing and non-corrosive electrodes and has been tested within a high temperature-high pressure system to check the performance of the device. Although the disclosed embodiments are suitable for use in a high temperature ultrasound transducer array, the detailed high temperature-design disclosed herein is not limited to monitoring acoustic emissions and conducting active probes (phase arrival) but can be employed also as pressure (load) sensors if the sensor is characterized and calibrated for a working load and temperature interval.

This application claims priority to U.S. Provisional Patent Application Serial No. 63/422,952, filed Nov. 5, 2022, the disclosure of which is incorporated herein by reference in its entirety.

### FIELD

This disclosure describes the structure of an ultrasonic probe that can withstand high temperatures.

### BACKGROUND

Ultrasound sensors are used to measure vibrations. These may be used to monitor engines or other devices. Conventional ultrasound sensors are made of low Curie temperature piezo-crystals supported with epoxies, electrodes and a backing mass, all of which are placed within a metal tubing of various dimensions depending on the application. Miniature piezo-sensors in needle form with dimensions of the tip as small as 0.3 mm (also known as “hydrophones”) are an example of classic miniature low-temperature sensors that have been used in tests where space is at a premium and in which positioning of probes within a few millimeters of the sample or closer is problematic.

While commercially available hydrophones are well suited for temperatures less than 150 °C, they typically fail at intermediate and high temperatures due to the combination of employing low Curie-temperature crystals, the separation of electrodes from the piezo-element and unstable epoxies that decompose at elevated temperatures. Moving to higher temperatures requires employing piezo-crystals with a high Curie temperature which will maintain the piezo-electric coupling effect and using appropriate materials throughout the sensor to prevent the above-described failures typical at elevated temperatures. High-temperature vibration sensors with relatively large element size (such as greater than 4-6 mm) made of a high Curie point piezoelectric element for monitoring engine vibration in aircraft have been employed at temperatures as high as 750 °C. Large sensors operating up to 650 °C are commercially available and are commonly used as pressure sensors for frequencies below 40 kHz. To withstand these high temperatures, the sensing part of the sensor is made of tourmaline discs and the sensor is fitted with a two-wire mineral insulated cable. However, employing such crystals in miniature piezo-sensors has been a challenge and no such sensors are currently commercially available.

Some of the major challenges to implementing stable extreme-temperature miniature piezo-sensors are as follows:
decreased conductivity of conductors at elevated temperature, which is important in designing both the charge carrier as well as the ground electrodes;
oxidization of electrodes, which leads to device failure;
the degradation of bonding of electrodes and the electrode-crystal connection: epoxies and other conventional bonding techniques including soldering are not useful at high-temperatures because they utilize bonding materials with a low melting point; and
Differential thermal expansion of the individual components in the sensor assembly can lead to loss of coupling between the piezoelectric crystal and the sample.

Consequently, there is a need in the high-pressure, high-temperature community to probe near field-emitted signals as well as perform more accurate active probes at extreme environmental conditions. Sensors for this task must tolerate extreme temperatures for many thermal cycles, be stable over prolonged periods, and be as small as possible; ideally only a fraction of the length scale characteristic of the sample.

### SUMMARY

The present disclosure is directed to miniature high-temperature ultrasound probes. A device comprising a high temperature piezo-element is disclosed, which is encapsulated within highly anti-oxidizing and non-corrosive electrodes and has been tested within a high temperature-high pressure system to check the performance of the device. Although the disclosed embodiments are suitable for use in a high temperature ultrasound transducer array, the detailed high temperature-design disclosed herein is not limited to monitoring acoustic emissions and conducting active probes (phase arrival) but can be employed also as pressure (load) sensors if the sensor is characterized and calibrated for a working load and temperature interval. High-temperature, high-pressure deformation apparatus such as solid medium Griggs-type apparatus, D-DIA, gas medium Paterson apparatus or their modified versions, as well as various Piston-cylinder and Diamond Anvil Apparatus will also benefit from this device.

According to one embodiment, an ultrasonic sensor is disclosed. The sensor comprises an outer housing; an exterior film that is microdot plasma welded to a distal end of the outer housing; a piezoelectric crystal disposed within the outer housing wherein one surface of the piezoelectric crystal is pressed against the exterior film; an electrode disposed within the outer housing, having an interior film disposed at its distal end, wherein the interior film is pressed against an opposite surface of the piezoelectric crystal; and an insulating housing disposed between the electrode and the outer housing. In some embodiments, the insulating housing is bonded to the outer housing. In certain embodiments, the insulating housing is bonded using MgO or alumina-based adhesive. In some embodiments, the exterior film is platinum or platinum-rhodium. In some embodiments, the interior film is platinum. In some embodiments, an inner diameter of the insulating housing is roughly the same as an outer diameter of the electrode. In some embodiments, the electrode has a lip on a distal end, wherein an outer surface of the lip contacts the piezoelectric crystal, and the insulating housing is pressed against an opposite surface of the lip. In some embodiments, the sensor comprises a ground electrode welded to an interior surface of the outer housing. In certain embodiments, a needle extends from a proximal end of the electrode. In certain embodiments, the sensor comprises a plug disposed on a proximal end of the outer housing. In certain embodiments, the plug comprises a plurality of through holes, wherein the needle and the ground electrode are each pushed into a respective through hole and the plug is held in place by the needle and the ground electrodes. In some embodiments, cables are disposed in the through holes and contact the needle and the ground electrode. In some embodiments, the plug is made of alumina.

According to another embodiment, an ultrasonic sensor is disclosed. The sensor comprises an outer housing; an exterior film affixed to a distal end of the outer housing; a piezoelectric crystal disposed within the outer housing wherein one surface of the piezoelectric crystal is pressed against the exterior film; and an electrode disposed within the outer housing in electrical contact with the piezoelectric crystal, wherein the ultrasonic sensor is capable of operation at temperatures greater than 900 °C and an outer diameter of the outer housing is 2.5 mm or less. In some embodiments, the piezoelectric crystal comprises AIN, LINDO3, Langatate (La₃Ga_{5.5}Ta_{0.5}O₁₄), or YACOB (YCa₄(BO₃)₃). In some embodiments, the exterior film is platinum or platinum-rhodium. In some embodiments, the ultrasonic sensor is capable of operation at temperatures greater than 1100 °C. In some embodiments, solder is not used in the manufacture of the ultrasonic sensor.

### BRIEF DESCRIPTION OF THE DRAWINGS

For a better understanding of the present disclosure, reference is made to the accompanying drawings, in which like elements are referenced with like numerals, and in which:

FIG. 1 shows a miniature high temperature ultrasonic sensor, according to one embodiment;

FIG. 2 shows the active end of the sensor;

FIG. 3 shows the center portion of the sensor;

FIG. 4 shows details of the upper part of the sensor;

FIGS. 5A-5C are photographs of a needle high temperature sensor within an assembly that may be used in high pressure high temperature testing on rocks and minerals;

FIGS. 6A-6D show two manufactured needle high temperature sensors with 2 and 2.5 mm diameters, respectively; and

FIGS. 7A-7B show actual test data.

### DETAILED DESCRIPTION

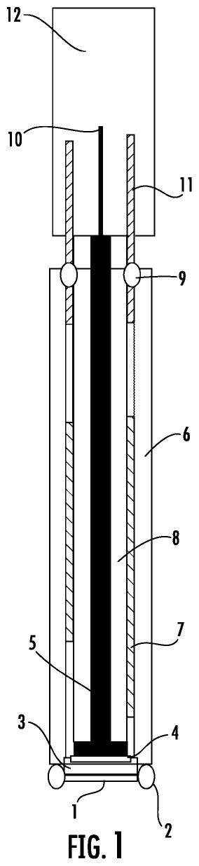

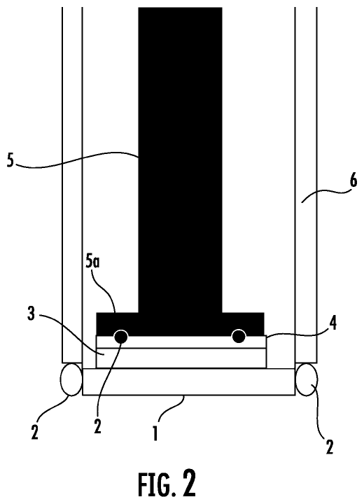

FIG. 1 shows the structure of the miniature high temperature ultrasonic sensor, also referred to as simply the sensor, according to one embodiment. The sensor is operable to 900 °C or higher. In some embodiments, the operating temperature range of the sensor may be 1100 °C or higher. Detailed views of parts of the sensor are shown in FIGS. 2-4.

In FIG. 1, the bottom end of the sensor represents the active portion of the sensor that is proximate the sample and performs the detection of ultrasonic waves.

The ultrasonic sensor utilizes a piezoelectric crystal 3. The piezoelectric crystal 3 may be made of a suitable material with a high Curie transition temperature as well as a melting point that is greater than 900 °C. These materials include AIN, LiNbO₃, Langatate (La₃Ga_{5.5}Ta_{0.5}O₁₄), or YACOB (YCa₄(BO₃)₃). AIN and Langatate are the most suitable materials at temperatures above 900 °C due to their small changes in electrical resistivity at these higher temperatures. The thickness of the piezoelectric crystal 3 defines the resonance frequency and, depending on the application, can be changed. For frequencies between 70 KHz and 5 MHz, this thickness may be about 1-2mm. The diameter may be less than 0.5 mm. As best seen in FIG. 2, disposed on one surface of the piezoelectric crystal 3 is an exterior film 1. The exterior film 1 may be platinum, platinum-rhodium or another suitable high-melting point, high conductivity and corrosion resistant material (such as tungsten carbide or tungsten-rhenium). The exterior film 1 may be 150 μm or thinner. The exterior film 1 may be circular in shape. The piezoelectric crystal 3 may be press fit against the exterior film 1. Disposed on the opposite surface of the piezoelectric crystal 3 is an interior film 4. Like the exterior film 1, the interior film 4 may be platinum or another suitable high-melting point, high conductivity and corrosion resistant material (such as tungsten carbide or tungsten-rhenium). The interior film 4 may be 50-100 um thick. In some embodiments, the piezoelectric crystal 3 is pressed against the exterior film 1 and the interior film 4, with no adhesives. The minimum normal stress on both sides of the piezoelectric crystal 3 is supported by certain contact points which are almost always in contact. Further, mismatched thermal expansion coefficients help to improve these contacts.

The piezoelectric crystal 3 and the interior film 4 are disposed within an outer housing 6. The outer housing 6 may be a hollow cylinder and may be made of tungsten carbide, Inconel 716 or another suitable conductive material having a melting point greater than 900 °C. In some embodiments, the outer housing 6 may have an outer diameter of 2.5 mm or smaller and the inner diameter of 2 mm or less. The length of the outer housing 6 is not limited by this disclosure, and may be 20 cm or more in length. Of course, other dimensions are also possible.

A microdot plasma weld 2 is used to adhere the exterior film 1 to the distal end of the outer housing 6. This microdot plasma weld 2 serves to secure the exterior film 1 to the outer housing 6 and provide electrical connectivity between these components. The exterior film 1 serves as a fixed membrane. The microdot plasma weld 2 also isolates the interior of the outer housing 6 from the exterior environment. The exterior film 1 and the outer housing 6 serve as the ground for the sensor. Since this weld does not utilize adhesives or solder, it is capable of withstanding high temperatures.

Returning to FIG. 1, an electrode 5 may be plasma welded to the interior film 4. The electrode 5 serves as the charge carrier element in the sensor. By pressing the electrode 5 against the piezoelectric crystal 3, the interior film 4 is able to contact both the electrode 5 and the piezoelectric crystal 3. The employed force may be about 15-20 N, inducing about 90-100 MPa compression stress on piezoelectric crystal 3 of ~0.5 mm in diameter. The electrode 5 may be an electrically conductive material, such as Inconel 718, AMS 5832, or another suitable material having a melting temperature greater than 900 °C

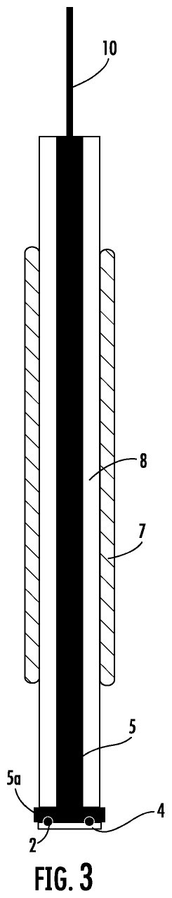

As best seen in FIG. 3, the electrode 5 may be a solid cylinder and may have a wider lip 5a at its distal end (near the piezoelectric crystal 3), forming a T-shape. The outer surface of the lip 5a faces the piezoelectric crystal 3 and may include microdot plasma welds 2 to affix it to the interior film 4. The lip 5a may extend outward from the body of the electrode 5 in the radial direction about 0.1 mm in some embodiments.

Referring to FIG. 3, an insulating housing 8, which may be a hollow cylinder, may encircle the electrode 5. In some embodiments, the distal end of the insulating housing 8 is pressed against the inner surface of the lip 5a. In some embodiments, the inner diameter of the insulating housing 8 may be roughly the same diameter as the outer diameter of the electrode 5. For example, the inner diameter of the insulating housing 8 may be larger than the outer diameter of the electrode 5 by about 0.05 mm or less. In this way, the electrode 5 does not move within the insulating housing 8. The inner diameter of the insulating housing may be about 0.5-1 mm in some embodiments. Further, in some embodiments, the outer diameter of the insulating housing 8 is smaller than the outer diameter of the lip 5a by about 0. 025 mm. This dimensioning may help to suppress thermal expansion of the piezoelectric crystal 3 and the separation of the electrode 5 from the piezoelectric crystal 3. As result of this dimensioning, the lip 5a of the electrode 5 is pushed-held with the insulating housing 8 if thermal expansion of the exterior film 1, the piezoelectric crystal 3 and/or the interior film 4 occurs. The insulating housing 8 may be made of alumina or another insulating material capable of withstanding high temperatures, such as greater than 900 °C

The outer surface of the insulating housing 8 may be coated with a bonding material 7. The bonding material 7 may be a high temperature ceramic bonding material. In other embodiments, the bonding material may be an MgO or an alumina based high temperature adhesive.

As seen in FIG. 1, the insulating housing 8 is disposed inside the outer housing 6. The bonding material 7 secures the insulating housing 8 to the outer housing 6. The bonding material 7 also adds extra resistance to the relative motion of these components resulting from thermal expansion. The length of the insulating housing 8 may be such that the proximal end of the insulating housing 8 is aligned with the proximal end of the outer housing 6.

Thus, the electrode 5 is press fit against the piezoelectric crystal 3. The electrode 5 is also tightly coupled to the insulating housing 8, which minimizes the relative motion of these two components. In this portion of the sensor, there are only two regions where plasma welding is used. The exterior film 1 is plasma welded to the outer housing 6. Additionally, the electrode 5 may be plasma welded to the interior film 4.

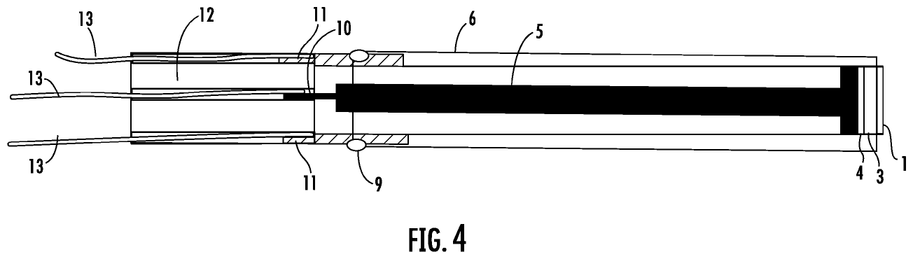

FIG. 4 shows the proximal end of the sensor and specifically the electrical connections. In certain embodiments, the proximal end of the electrode 5 is shaped as a needle 10. The diameter of the needle may be 0.1 mm for example. The needle 10 may be concentric with the body of the electrode 5. In some embodiments, the needle 10, the lip 5a and the electrode 5 are one integral component.

Additionally, one or more ground electrodes 11 may be arc-welded within the outer housing 6 at welding points 9, such that they are disposed between the interior of the outer housing 6 and the exterior of the insulating housing 8. Platinum-rhodium mineral insulated (MI) cables 13 may be mechanically fastened and electrically connected to the ground electrodes 11 and to the needle 10.

An alumina plug 12 is disposed on the proximal end of the outer housing 6 and held in place by needle 10 and ground electrodes 11. The alumina plug 12 has a plurality of through holes.

The ground electrodes 11 and needle 10 are pushed into respective through holes of the alumina plug 12 where they sandwich the cables 13 between the electrodes and the interior surface of the holes. This allows a stable connection of the electrodes with the cables 13 and adds extra resistance to motion for needle 10 and ground electrodes 11. The cables 13 may pass through the through holes of the alumina plug 12 to allow the ground and signal sides of the piezoelectric crystal 3 to be electrically connected to another device at the proximal end of the alumina plug 12. In some embodiments, this device may be an amplifier to amplify the voltage due to release of charge in the piezoelectric crystal 3, which is the result of vibration of the crystal. The output from this amplifier may be provided to a data acquisition system. This configuration is used when the sensor is only in listening or passive mode. In certain embodiments, the cables 13 may be connected to an ultrasonic pulsing system which generates an electrical impulse to excite the piezoelectric crystal 3 and generate vibrations. This configuration is used when the piezoelectric crystal 3 is driven externally.

Note that while the plug is described as being made of alumina, other suitable materials, which include high temperature ceramics such as zirconia may also be used.

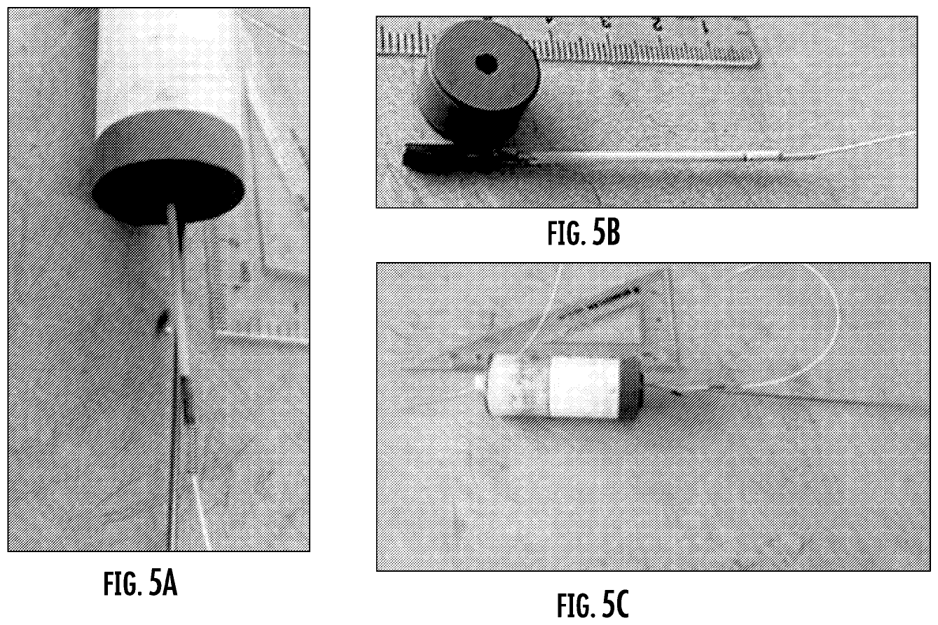

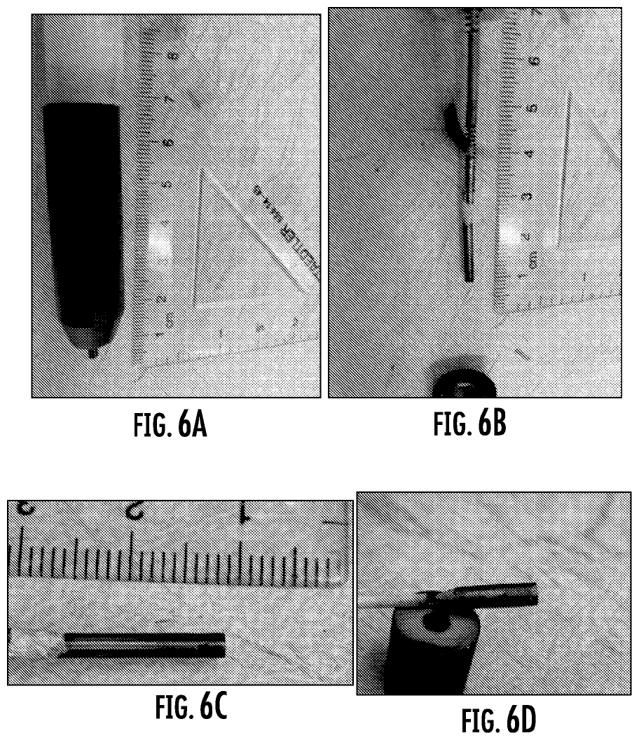

FIGS. 5A-5C shows photographs of a needle type high temperature ultrasonic sensor with an assembly that may be used with high temperature high pressure testing on rocks and minerals. FIGS. 6A-6D show photographs of two different sensors, manufactured with a 2.0 mm and 2.5 mm diameter, respectively.

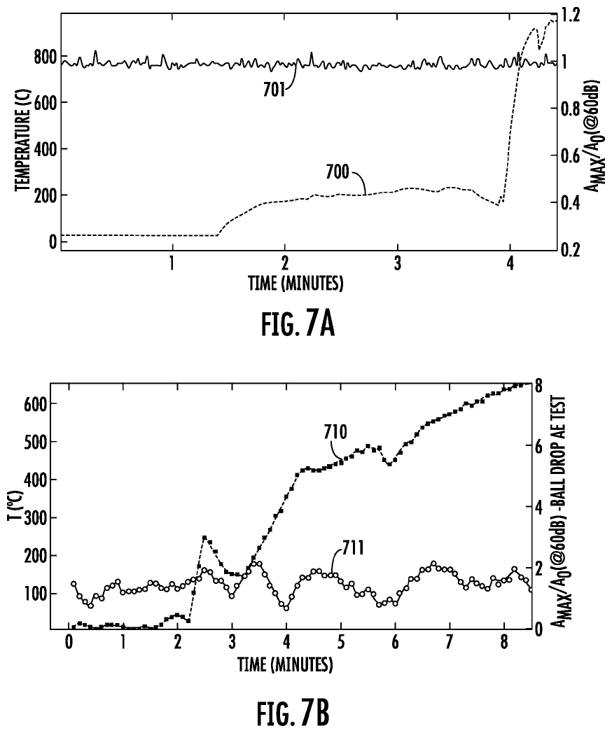

The present system has many advantages. The design of this ultrasonic sensor is compact and yet is able to withstand very high temperatures. FIG. 7A shows the short term response of the Sensor within a butane flame. The tip of the sensor is moved various distances from the flame to vary the temperature. Line 700 shows the temperature at the tip of the sensor using the scale on the left vertical axis, while line 701 shows the pulse echo response using the scale on the right vertical axis. Note that there is little to no variation in response due to temperature. FIG. 7B shows the recorded acoustic emissions when a ball is dropped. As above, the sensor is maintained various distances from the butane flame to vary temperature. Line 710 shows the temperature at the tip of the sensor using the scale on the left vertical axis, while line 711 shows the relative maximum amplitude of recorded acoustic emissions using the scale on the right vertical axis. Again, there is little variation in the recorded emission due to fluctuations in temperature. This is achieved through the use of materials that have high melting points (such as above 900 °C), including the piezoelectric crystal 3, the exterior film 1, the interior film 4, the outer housing 6, and the insulating housing 8. Additionally, the piezoelectric crystal 3 has a high Curie point and low electrical conductivity. Further, all bonding is achieved without the use of solder. Rather, plasma microdot welding, high temperature adhesives and arc welding are used to create all connections.

Further, this sensor described herein is miniature and can be made with an outer diameter at the tip of roughly 2 mm. This allows the sensor to be used in applications where larger sensors simply cannot fit.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. An ultrasonic sensor, comprising:
an outer housing;
an exterior film that is microdot plasma welded to a distal end of the outer housing;
a piezoelectric crystal disposed within the outer housing wherein one surface of the piezoelectric crystal is pressed against the exterior film;
an electrode disposed within the outer housing, having an interior film disposed at its distal end, wherein the interior film is pressed against an opposite surface of the piezoelectric crystal; and
an insulating housing disposed between the electrode and the outer housing.

2. The ultrasonic sensor of claim 1, wherein the insulating housing is bonded to the outer housing.

3. The ultrasonic sensor of claim 2, wherein the insulating housing is bonded using MgO or alumina-based adhesive.

4. The ultrasonic sensor of claim 1, wherein the exterior film is platinum or platinum-rhodium.

5. The ultrasonic sensor of claim 1, wherein the interior film is platinum.

6. The ultrasonic sensor of claim 1, wherein the interior film is plasma welded to the distal end of the electrode.

7. The ultrasonic sensor of claim 1, wherein an inner diameter of the insulating housing is roughly the same as an outer diameter of the electrode.

8. The ultrasonic sensor of claim 1, wherein the electrode has a lip on a distal end, wherein an outer surface of the lip contacts the piezoelectric crystal, and the insulating housing is pressed against an opposite surface of the lip.

9. The ultrasonic sensor of claim 1, further comprising a ground electrode welded to an interior surface of the outer housing.

10. The ultrasonic sensor of claim 9, wherein a needle extends from a proximal end of the electrode.

11. The ultrasonic sensor of claim 10, further comprising a plug disposed on a proximal end of the outer housing.

12. The ultrasonic sensor of claim 11, wherein the plug comprises a plurality of through holes, wherein the needle and the ground electrode are each pushed into a respective through hole and the plug is held in place by the needle and the ground electrode.

13. The ultrasonic sensor of claim 12, wherein cables are disposed in the through holes and contact the needle and the ground electrode.

14. The ultrasonic sensor of claim 13, wherein the cables are electrically connected to an amplifier, a data acquisition system or an ultrasonic pulsing system.

15. The ultrasonic sensor of claim 11, wherein the plug is made of alumina.

16. An ultrasonic sensor comprising:
an outer housing;
an exterior film affixed to a distal end of the outer housing;
a piezoelectric crystal disposed within the outer housing wherein one surface of the piezoelectric crystal is pressed against the exterior film; and
an electrode disposed within the outer housing in electrical contact with the piezoelectric crystal, wherein the ultrasonic sensor is capable of operation at temperatures greater than 900 °C and an outer diameter of the outer housing is 2.5 mm or less.

17. The ultrasonic sensor of claim 16, wherein the piezoelectric crystal comprises AlN, LiNDO₃, Langatate (La₃Ga_{5.5}Ta_{0.5}O₁₄), or YACOB (YCa₄(BO₃)₃).

18. The ultrasonic sensor of claim 16, wherein the exterior film is platinum or platinum-rhodium.

19. The ultrasonic sensor of claim 16, wherein the ultrasonic sensor is capable of operation at temperatures greater than 1100 °C.

20. The ultrasonic sensor of claim 16, wherein solder is not used in the manufacture of the ultrasonic sensor.
